(19) United States
(12) Patent Application Publication
(10) Pub. No.: US 2021/0121773 A1
(43) Pub. Date: Apr. 29, 2021

(54) INTERCONNECTED MAZE BOOK

(71) Applicant: Brian Turner Lewis, Greensboro, NC (US)

(72) Inventor: Brian Turner Lewis, Greensboro, NC (US)

(21) Appl. No.: 17/082,376

(22) Filed: Oct. 28, 2020

Related U.S. Application Data
(60) Provisional application No. 62/926,624, filed on Oct. 28, 2019.

(51) Int. Cl. A63F 9/00; G09B 11/04

(52) U.S. Cl. CPC A63F 9/0078; G09B 11/04

(57) ABSTRACT

The present invention is directed to a maze book comprising a plurality of pages including a last page, a binding, and a maze comprising a starting location and pathways to choose to solve the maze, wherein each page comprises a front page and a back page, wherein the front page and back page each comprise a partial maze comprising a pathway, the partial maze incapable of being solved on its own on the front page, and an indicator wherein the page can be altered to align the indicator on the back page to the indicator on the front page; wherein each page is aligned with the back page, using the indicator, so that the pathway of the partial maze on the front page will align with the pathway of the partial maze on the back page; and wherein the pathway of the partial maze on the back page will be aligned to the pathway of the partial maze on the front page of the next page, through a gap made visible by the fold; wherein the partial mazes of the pages can be interconnected and the maze solved.

### CROSS REFERENCE TO RELATED APPLICATIONS

This application claims priority to U.S. Provisional Patent Application No. 62/926,624 filed Oct. 28, 2019, the entirety of which is incorporated by reference herein.

### FIELD OF THE INVENTION

The present invention relates to printed mazes, and more particularly, to a book of mazes in which each sheet contains one or many mazes.

### BACKGROUND OF THE INVENTION

A maze is a puzzle and typically comprises a structure having a starting point, a finish point, and a collection of complex branching passageway there between. A person tries to navigate the maze passageways from the starting point to the finish point. There are several choices to make to solve the maze. A wrong choice results in a dead end. In a basic maze the walls or borders which define the maze passageways are fixed. In another type of maze, the walls and passageways of the maze are reconfigurable. The word “maze” dates from the 13th century and comes from the Middle English word mæs, denoting delirium or delusion. The word “labyrinth” may date as far back as the 14th century, and derives from the Latin labyrinthus and the Greek labyrinthus, or, a building with intricate passages.

Current books contain printed mazes wherein the printed mazes and methods of construction limit the printed maze to only be played on one sheet, thus isolating each printed maze and making each printed maze a separate maze altogether.

### SUMMARY OF THE INVENTION

The maze book of the present invention includes a cover, a binding, a page that may include a story, inventory or rules, and a plurality of maze pages including a last page wherein each maze page includes a starting location and pathways to choose to solve the maze, wherein each maze page comprises a front maze page and a back maze page;
A) wherein the front maze page and back maze page each have a partial maze comprising a pathway, the partial maze incapable of being solved on its own on the front maze page, and an indicator wherein the maze page can be altered to align the indicator on the back maze page to the indicator on the front maze page;
B) wherein each maze page is aligned with the back maze page, using the indicator, so that the pathway of the partial maze on the front maze page will align with the pathway of the partial maze on the back maze page; and
C) wherein the pathway of the partial maze on the back maze page will be aligned to the pathway of the partial maze on the front maze page of the next maze page, through a gap made visible by the fold; wherein the partial mazes of the maze pages can be interconnected and the maze solved.

Another object of the present invention is the option wherein the indicator is on the maze, in particular, on the pathway of the partial maze on the back maze page and can be aligned with the pathway of the partial maze of the front maze page, wherein the maze page can be folded upwards and down on said front maze page from the right of said front maze page, to the left of said front maze page or towards aligning the indicator on the back maze page to the indicator on the front maze page.

Another object of the present invention is the option wherein the last maze page in the plurality of maze pages does not include a partial maze on back side of said page.

Another object of the present invention is the option wherein the indicator is a mark, line, symbol, image, or printed indicator.

Another object of the present invention is the option wherein solving the maze can be done by turning the maze pages forward or backward during the solving of the maze.

Another object of the present invention is the option wherein solving the maze can be repeated with each consecutive maze page until the last maze page of the book. Solutions can require moving forward or backward through the book, not just forward to the last maze page.

The present invention further includes a method for solving a maze book of the present invention, having the steps of:
A) opening the maze book to a maze page having a partial maze, the maze book having a plurality of pages including a last maze page, a binding, and a partial maze having a starting location and pathways to choose to solve the maze, wherein each maze page has a front maze page and a back maze page, wherein the front maze page and back maze page each has a partial maze comprising a pathway, the partial maze incapable of being solved on its own on the front maze page, and an indicator wherein the maze page can be altered to align the indicator on the back maze page to the indicator on the front maze page;
B) beginning at a start point in a pathway in the maze, follow the pathway until a dead end or at any point in the pathway that is revealed after the maze page is folded is reached;
C) aligning the front maze page with the back maze page, using the indicator, so that the pathway of the partial maze on the front maze page will align with the pathway of the partial maze on the back maze page wherein the pathway of the partial maze on the back maze page will be aligned to the pathway of the partial maze on the front maze page of the next maze page, through a gap made visible by the fold; and
D) continuing to follow the maze until the maze is solved.

Another object of the method of the present invention is the option wherein the method includes E) aligning the indicator on the maze and the pathway of the partial maze on the back maze page with the pathway of the partial maze of the front maze page wherein the maze page can be folded upwards and down on said front maze page from the right of said front maze page, to the left of said front maze page or towards aligning the indicator on the back maze page to the indicator on the front page.

Another object of the method of the present invention is the option wherein the method includes the back maze page of the last maze page does not include a partial maze.

Another object of the method of the present invention is the option wherein the maze book further has a cover and a page comprising a story, inventory, and rules.

Another object of the method of the present invention is the option wherein the indicator is a mark, line, symbol, image, or printed indicator.

Another object of the method of the present invention is the option wherein solving the maze can be done by turning the maze pages forward or backward during the solving of the maze.

The invention accordingly comprises the features of construction, combination of elements, arrangement of parts, and method, which will be exemplified in the construction hereinafter set forth, and the scope of the invention will be indicated in the claims.

### BRIEF DESCRIPTION OF THE DRAWINGS

FIG. 1 is a top plan view of the maze book game in accordance with the present invention;

FIG. 2 is a second top plan view of the maze book in accordance with the present invention; and

FIG. 3 is a third top plan view of the maze book in accordance with the present invention.

### DETAILED DESCRIPTION OF THE INVENTION

In general, the present invention is directed to a maze book 100 including a plurality of maze pages 101 including a last page 102, a binding 103, and a partial maze 104 having a starting location 105 and pathways 106 to choose to solve the maze, wherein each maze page 101 has a front maze page 101a and a back maze page 101b wherein
A) the front maze page 101a and back maze page 101b each include a partial maze 104 having a pathway 106, the partial maze 104 incapable of being solved on its own on the front maze page 101a, and an indicator 107 wherein the maze page 101 can be altered to align the indicator 107 on the back maze page 101b to the indicator 107 on the front maze page 101a;
B) each maze page 101 is aligned with the back maze page 101b, using the indicator 107, so that the pathway 106 of the partial maze 104 on the front maze page 101a will align with the pathway 106 of the partial maze 104 on the back maze page 101b; and
C) the pathway 106 of the partial maze 104 on the back maze page 101b will be aligned to the pathway 106 of the partial maze 104 on the front maze page 101a of the next maze page, through a gap made visible by the fold; wherein the partial mazes 104 of the maze pages 101 can be interconnected and the maze solved.

The maze book 100 according to the present invention further includes an indicator 107 on the partial maze 104 and the pathway of the partial maze 104 on the back maze page 101b can be aligned with the pathway of the partial maze 104 of the front maze page 101a wherein the maze page 101 can be folded upwards and down on said front maze page 101a from the right of said front maze page 101a, to the left of said front maze page 101a or towards aligning the indicator 107 on the back maze page 101b to the indicator 107 on the front maze page 101a.

The maze book 100 according to the present invention can be made by printing the maze onto the maze pages 101 of the maze book 100.

The maze book 100 according to the present invention further includes a back maze page 101a of the last maze page 102 in the plurality of maze pages 101 does not include a partial maze 104.

The maze book 100 according to the present invention further includes a cover 108 and a page 109 or pages comprising a story, inventory, and rules.

The maze book 100 according to the present invention, wherein the indicator 107 is a mark, line, symbol, image, or printed indicator.

The maze book 100 according to the present invention, wherein solving the maze can be done by turning the maze pages forward or backward during the solving of the maze. A solution may require one to have to move forward and backward though the pages. All the maze pages are potential parts of the one or many solutions in the book, with the folds connecting them all together.

The maze book 100 according to the present invention, wherein solving the maze can be repeated with each consecutive maze page 101 until the last maze page 102.

A method for solving a maze book 100 the present invention including the steps of:
A) opening a maze book 100 to a maze page 101 comprising a partial maze 104, the maze book 100 comprising a plurality of pages 101 including a last maze page 102, a binding 103, and a partial maze 104 comprising a starting location 105 and pathways 106 to choose to solve the maze, wherein each maze page 101 comprises a front maze page 101a and a back maze page 101b, wherein the front maze page 101a and back maze page 101b each comprise a partial maze 104 comprising a pathway 106, the partial maze 104 incapable of being solved on its own on the front maze page 101a, and an indicator 107 wherein the maze page 101 can be altered to align the indicator 107 on the back maze page 101b to the indicator on the front maze page 101a;
B) beginning at a start point in a pathway 106 in the partial maze 104, follow the pathway 106 until a dead end or at any point in the pathway that is revealed after the maze page is folded is reached;
C) aligning the front maze page 101a with the back maze page 101b, using the indicator 107, so that the pathway 106 of the partial maze 104 on the front maze page 101a will align with the pathway 106 of the partial maze 104 on the back maze page 101b wherein the pathway 106 of the partial maze 104 on the back maze page 101b will be aligned to the pathway 106 of the partial maze 104 on the front maze page 101a of the next maze page 101, through a gap made visible by the fold; and
D) continuing to follow the maze until the maze is solved including turning the maze pages 101 back and forth while folding the maze page 101.

The method according to the present invention, wherein the indicator 107 on the partial maze 104 and the pathway 106 of the partial maze 104 on the back maze page 101b can be aligned with the pathway 106 of the partial maze 104 of the front maze page 101a, wherein the maze page 100 can be folded upwards and down on said front maze page 101a from the right of said front maze page 101a, to the left of said front maze page 101a or towards aligning the indicator on the back maze page 101b to the indicator 107 on the front maze page 101a.

The method according to the present invention, wherein the maze book 100 has a back maze page 101b of the last maze page 102 does not include a partial maze 104.

The method according to the present invention, wherein the maze book 100 further includes a cover 108 and a page(s) 109 comprising a story, inventory, and rules.

The method according to the present invention, wherein the indicator 107 is a mark, line, symbol, image, or printed indicator.

The method according to the present invention, wherein solving the maze can be done by turning the maze pages forward or backward during the solving of the maze.

The method according to the present invention, wherein the method can be repeated with each consecutive maze page until the last maze page 102 of the maze book 100.

A maze book constructed in accordance with the present invention has a plurality of maze pages 101. Each maze page 101 includes printing on the front maze page 101a containing one partial maze 104 including a pathway 106, incapable of being solved on its own. Printed on the front maze page 101b, except for the last maze page 102 contains one or many partial mazes including pathways, incapable of being solved on its own. Printed on each said maze page 101 except for the last page 102, has a mark, line or printed indicator 107 on the front maze page 101a and back maze page 101b, expressing to the user to fold upwards and down on said maze page 101 from the right of said sheet, to the left of said sheet or towards the binding 103 of present maze book, aligning the mark, line, symbol, image, or printed indicator 107 on the back maze page 101b to the mark, line, symbol, image, or printed indicator on the front maze page 101a. When said maze page 201 is folded and aligned with the back maze page 101b, using the mark, line, or printed indicator 107, the pathways of the partial maze 104 on the front maze page 101a will align with the pathways 106 of the partial maze 104 on the back maze page 101b. The pathways 106 of the partial maze 104 on the back maze page 101b will be aligned to the pathways of the partial maze 104 on the front maze page 101a of the next maze page 101, after said sheet, in the maze book 100, through the gap made visible by the fold. After said maze page 101 is turned, this process can be repeated with each consecutive maze page 101, until the last maze page 101 in the maze book 100. By this process or reversal of the process, all unsolvable mazes printed on either the front or back of each sheet in the maze book 100 can be interconnected and solved. The maze book 100 must contain at least one and up to any number of start locations indicated by printed mark or illustration, and located within the partial maze 104 on any maze page 101 within the maze book 100.

Another object of the present invention is the option to include at least one but up to any number of end location solutions, all requiring the above mentioned process to solve. If the maze book 100 has more than one end location solution, a solution sheet may be added into the said book to allow the player to keep track of their progress. End location solutions may take the form, but are not limited to, printed words, characters, numbers, shapes, stickers, and any combination of the aforementioned forms.

A further object of the present invention is the option to incorporate stories, and illustrations, that create themes which enhance the look and appeal of the present invention. Additional pages may be inserted either at the beginning or end of the book to express these themes. Subsequently, illustrations and stories may be printed, and incorporated into the maze and pathways of each sheet giving the whole book a more unified feel.

The invention accordingly comprises the features of construction, combination of elements, and arrangement of parts which will be exemplified in the construction hereinafter set forth, and the scope of the invention will be indicated in the claims.

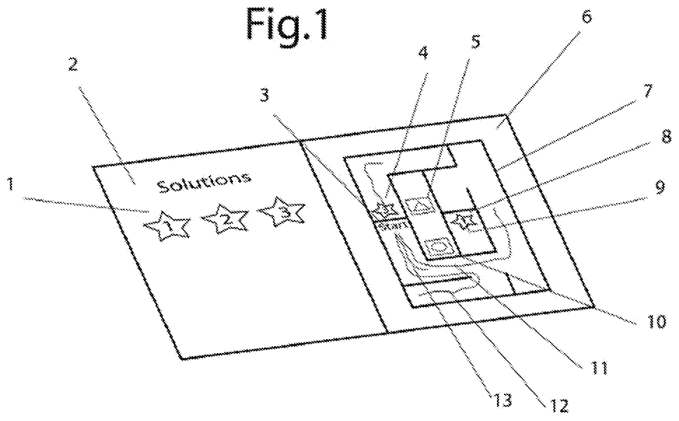

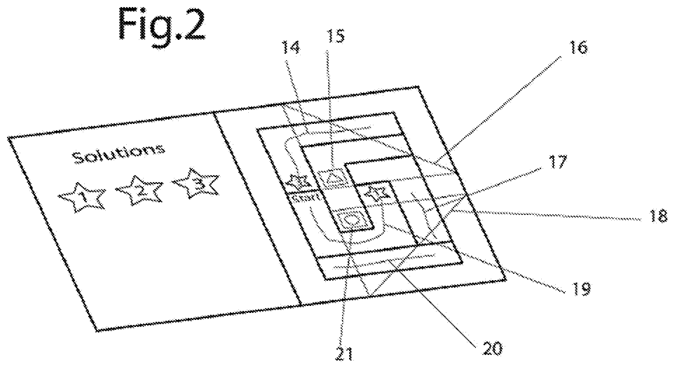

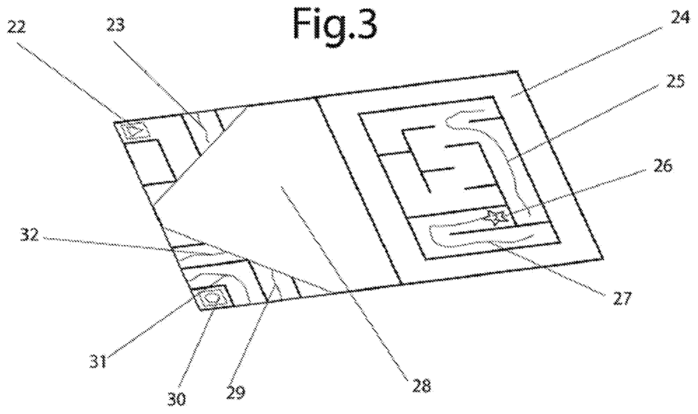

Referring initially to FIGS. 1-3, there is illustrated a top plan view of a maze game showing the following features:

1. Shows a top plan view of an open maze book 100 of all solutions in the maze book 100 that a player is trying to find
2. A solutions maze page 110 shows all possible solutions in the maze book 100.
3. FIG. 1 further shows a start position 105, where the player starts the partial maze 104.
4. Particular solution (3) found on solutions maze page 110, what player is trying to find
5. Front page indicator 107 of where to fold back maze page 101b indicator to.
6. A border of maze 111 on front maze page 101a, where artwork can be put to provide theme for the maze book 100.
7. A partial maze 104 on front maze page
8. A particular solution (1) found on solutions maze page 110, what player is trying to find
9. A path the player marks to find solution, when page is folded, matches with #19
10. A front page indicator 107a of where to fold back maze page indicator 107b to.
11. A path the player marks to find solution, when maze page is folded, matches with #17
12. A path the player marks to find solution, when maze page 101 is folded, matches with #20
13. A path the player marks to find solution, when maze page 101 is folded, matches with #19
14. A path the player marks to find solution, when maze page 101 is folded, matches with #25, and #4
15. A back maze page indicator 107b folded on top and aligning with front maze page indicator 107a.
16. The border of the maze 111 from the back maze page 101b, aligned with the front maze page 101a.
17. A path the player marks to find solution, when maze page 100 is folded, matches with #11, and #25
18. The border of the maze 111 from the back maze page 100b, aligned with the front maze page 100a.
19. A path the player marks to find solution, when maze page 100 is folded, matches with #9 and #13
20. A path the player marks to find solution, when maze page 100 is folded, matches with #12 and #27
21. The back page indicator 107b folded on top and aligning with front maze page indicator 107a.
22. The back maze page indicator 107b that when folded, aligns with front maze page indicator 107a.
23. An identical path as in #14 but viewed from the back maze page 101b perspective.
24. The border of maze 111 on front maze page 101a of next page, where artwork can be put to provide theme for book
25. A path the player marks to find solution, when maze page 101 is folded, matches with #14, and #17
26. A particular solution (2) found on solutions page, what player is trying to find.
27. A path the player marks to find solution, when maze page 101 is folded, matches with #20
28. The back maze page 101b, space used for images, text, or anything to enhance the maze or theme.
29. An identical path as in #20 but viewed from the back maze page 101b perspective.
30. The back maze page indicator 107b that when folded, aligns with front maze page indicator 107a.
31. An identical path as in #19 but viewed from the back maze page 101b perspective.
32. An identical path as in #17 but viewed from the back maze page 101b perspective.

1. A maze book comprising a plurality of maze pages including a last page, a binding, and a maze comprising a starting location and pathways to choose to solve the maze, wherein each maze page comprises a front maze page and a back maze page;
A) wherein the front maze page and back maze page each comprise a partial maze comprising a pathway, the partial maze incapable of being solved on its own on the front maze page, and an indicator wherein the maze page can be altered to align the indicator on the back maze page to the indicator on the front maze page;
B) wherein each page is aligned with the back maze page, using the indicator, so that the pathway of the partial maze on the front maze page will align with the pathway of the partial maze on the back maze page; and
C) wherein the pathway of the partial maze on the back maze page will be aligned to the pathway of the partial maze on the front maze page of the next maze page, through a gap made visible by the fold; wherein the partial mazes of the maze pages can be interconnected and the maze solved.

2. The maze book according to claim 1, wherein the indicator is on the maze and the pathway of the partial maze on the back maze page can be aligned with the pathway of the partial maze of the front maze page wherein the page can be folded upwards and down on said front maze page from the right of said front maze page, to the left of said front maze page or towards aligning the indicator on the back maze page to the indicator on the front maze page.

3. The maze book according to claim 1, comprising the back maze page of the last maze page in the plurality of maze pages does not include a partial maze.

4. The maze book according to claim 1, further comprising a solutions page.

5. The maze book according to claim 1, further comprising a cover and a page or pages comprising a story, inventory, and rules.

6. The maze book according to claim 1, wherein the indicator is a mark, line, symbol, image, or printed indicator.

7. The maze book according to claim 1, wherein solving the maze can be done by turning the maze pages forward or backward during the solving of the maze.

8. A method for solving a maze book comprising the steps of:
A) opening a maze book to a maze page comprising a partial maze, the maze book comprising a plurality of pages including a last maze page, a binding, and a partial maze comprising a starting location and pathways to choose to solve the maze, wherein each maze page comprises a front maze page and a back maze page, wherein the front maze page and back maze page each comprise a partial maze comprising a pathway, the partial maze incapable of being solved on its own on the front maze page, and an indicator wherein the maze page can be altered to align the indicator on the back maze page to the indicator on the front maze page;
B) beginning at a start point in a pathway in the maze, follow the pathway until a dead end is reached;
C) aligning the front maze page with the back maze page, using the indicator, so that the pathway of the partial maze on the front maze page will align with the pathway of the partial maze on the back maze page wherein the pathway of the partial maze on the back maze page will be aligned to the pathway of the partial maze on the front maze page of the next maze page, through a gap made visible by the fold; and
D) continue to follow the maze until the maze is solved.

9. The method according to claim 8, wherein the indicator on the maze and the pathway of the partial maze on the back maze page can be aligned with the pathway of the partial maze of the front maze page wherein the maze page can be folded upwards and down on said front maze page from the right of said front maze page, to the left of said front maze page or towards aligning the indicator on the back maze page to the indicator on the front page.

10. The method according to claim 8, the maze book further comprising the back maze page of the last maze page in the plurality of maze pages does not include a partial maze.

11. The method according to claim 8, the maze book further comprises a solutions page.

12. The method according to claim 8, the maze book further comprising a cover and a page comprising a story, inventory, and rules.

13. The method according to claim 8, wherein the indicator is a mark, line, symbol, image, or printed indicator.

14. The method according to claim 8, wherein solving the maze can be done by turning the maze pages forward or backward during the solving of the maze.

15. The method according to claim 8, wherein the method can be repeated with each consecutive maze page until the last maze page of the book.
